(19) United States
(12) Patent Application Publication
(10) Pub. No.: US 2005/0154575 A1
(43) Pub. Date: Jul. 14, 2005

(54) Value stream improvement process simulation

(76) Inventors: James M. Whitman II, Sumner, WA (US); Kathryn K. Rusten Treiber, Bonney Lake, WA (US)

Correspondence Address: HARNESS, DICKEY & PIERCE, P.L.C., P.O. BOX 828, BLOOMFIELD HILLS, MI, 48303, US

(21) Appl. No.: 10/756,489

(22) Filed: Jan. 13, 2004

(51) Int. Cl. G06F 9/45

(52) U.S. Cl. 703/22

(57) ABSTRACT

Systems and methods for training participants about value streams through simulation and role-playing in which the participants assume different roles and actually assemble a physical model to conduct and evaluate production system scenarios. A training method generally includes simulating a first assembly scenario by having one or more participants assemble a physical model in accordance with the first assembly scenario, and simulating a second assembly scenario by having the participants assemble the physical model in accordance with the second assembly scenario. The second assembly scenario includes at least one value stream improvement in comparison to the first assembly scenario. The method can also include comparing the simulations, for example, to demonstrate the feasibility and effectiveness of the value stream improvement.

### FIELD OF THE INVENTION

The present invention generally relates to value stream improvements for production processes, and more particularly (but not exclusively) to methods and systems for training participants about the value stream improvement process through simulation and role-playing, and in which participants assume different roles and actually assemble a physical model to conduct, evaluate, and compare production system scenarios.

### BACKGROUND OF THE INVENTION

A value stream includes those actions (both value added and non-value added) that are required to bring a product from raw material to the customer. Traditional approaches for educating people about value streams are lecture oriented without participant interaction and participation. Such approaches usually do not provide effective demonstrations as to how value streams can be improved.

### SUMMARY OF THE INVENTION

The inventors hereof have invented apparatus and methods for more effectively training participants about value streams through simulation and role-playing, and in which the participants assume different roles and actually assemble a physical model to conduct, evaluate and/or compare production system scenarios.

In a preferred implementation, a method generally includes simulating a first assembly scenario by having one or more participants assemble a physical model in accordance with the first assembly scenario, and simulating a second assembly scenario by having the participants assemble the physical model in accordance with the second assembly scenario. The second assembly scenario includes at least one value stream improvement in comparison to the first assembly scenario. The method can also include comparing the simulations, for example, to demonstrate the feasibility and effectiveness of the value stream improvement.

The features, functions, and advantages can be achieved independently in various embodiments of the present inventions or may be combined in yet other embodiments.

### BRIEF DESCRIPTION OF THE DRAWINGS

The present invention will become more fully understood from the detailed description and the accompanying drawings, wherein:

FIG. 1 illustrates a supplier responsibility plan for assembling a model airplane according to a first assembly scenario;

FIG. 2 is a value stream diagram for the first assembly scenario;

FIG. 3 illustrates a supplier responsibility plan for assembling the model airplane according to a second assembly scenario;

FIG. 4 is a value stream diagram for the second assembly scenario;

FIG. 5 illustrates a supplier responsibility plan for assembling the model airplane according to a third assembly scenario;

FIG. 6 is a value stream diagram of the third assembly scenario;

FIGS. 7A through 7C respectively illustrate material flow icons, information flow icons, and general icons used in the value stream diagrams shown in FIGS. 2, 4, and 6;

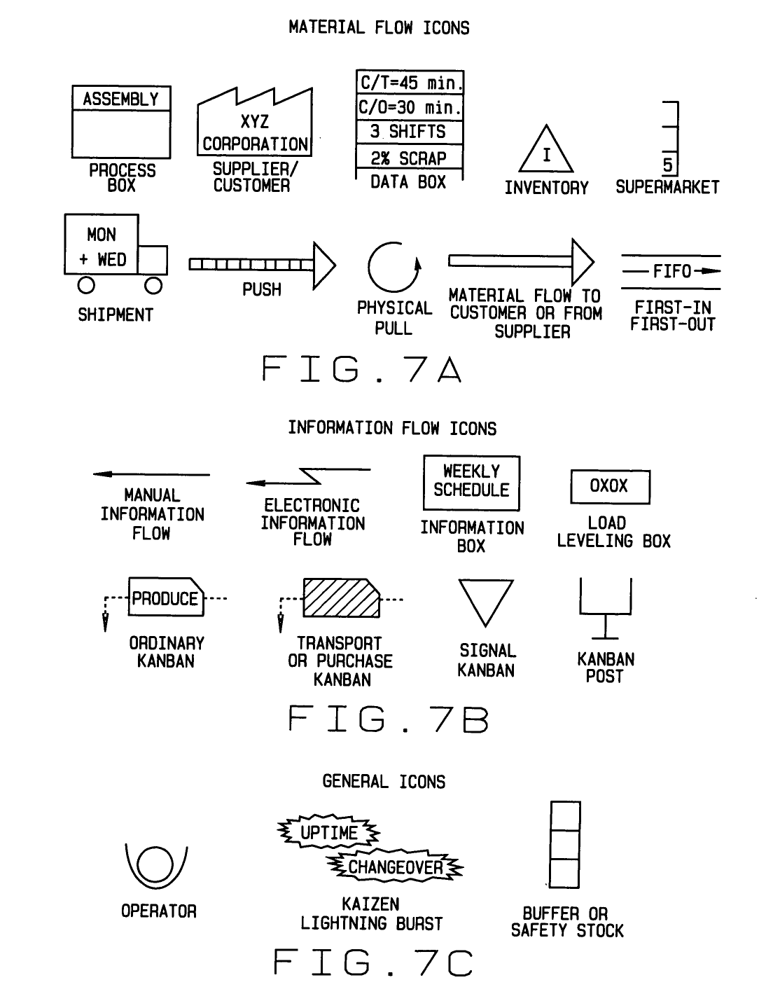

FIG. 8 illustrates the value of incremental value stream alignment over time;

FIGS. 9A and 9B respectively illustrate a current state and a future state exhibiting improved flow for an aircraft production process;

FIG. 10 is a process flow diagram for calculating economic profit;

FIG. 11 illustrates a process scorecard created in accordance with the process flow diagram of FIG. 10 for the first, second and third assembly scenarios;

FIG. 12 illustrates a unit cost scorecard created in accordance with the process flow diagram of FIG. 10 for the first, second and third assembly scenarios;

FIG. 13 illustrates a value stream improvement implementation plan which defines the future state of the first assembly scenario becoming the second assembly scenario; and

FIG. 14 illustrates another value stream improvement implementation plan which defines the future state of the second assembly scenario become the third assembly scenario.

### DETAILED DESCRIPTION OF THE PREFERRED EMBODIMENTS

The following description of the preferred embodiments is merely exemplary in nature and is in no way intended to limit the invention, its application, or uses.

Various aspects of the present invention provide highly effective ways of training participants about value streams through simulation and role-playing in which the participants assume different roles and actually assemble a physical model to conduct, evaluate, and compare various production system scenarios. In a preferred implementation, participants assemble a physical model in accordance with each of three different assembly scenarios, namely a current state or traditional manufacturing environment, a future state exhibiting improved flow, and a continuous flow moving production line.

The simulations can then be compared so as to at least demonstrate the feasibility and/or effectiveness of value stream improvements being made as the students progress through the assembly scenarios. Such value stream improvements can include supplier consolidation and integration, larger assemblies, continuous flow, elimination of waste or activities which do not add value to the final product, standardizing work, producing to customer demand using a pull system, right-sized equipment, point-of-use kits, etc. This interactive training can provide graphic illustrations of the differences between the simulated assembly scenarios, for example, in terms of efficiency, economic profit, productivity, inventory, work in process, flow, value stream alignment, etc. Accordingly, the present invention provides highly effective methods and systems for training people about value streams and the general principles relating thereto.

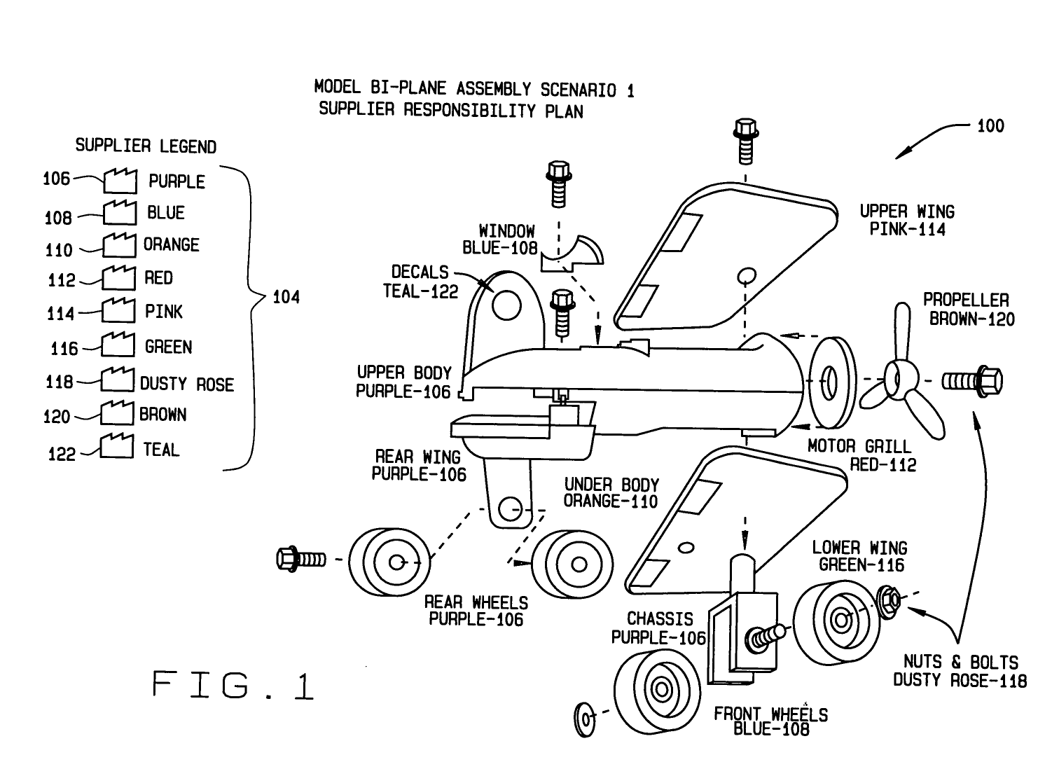

FIGS. 1 through 6 illustrate a preferred implementation in which a training method generally includes participants assembling a commercially available put-together/take-apart model of a toy airplane in accordance with three different assembly scenarios 100, 200, and 300. It should be noted, however, that implementations of the invention are not limited to the toy airplane model as the invention can include simulation of a wide range of assembly and/or manufacturing processes and models, such as those involving the manufacture of automobiles, trains, widgets, etc.

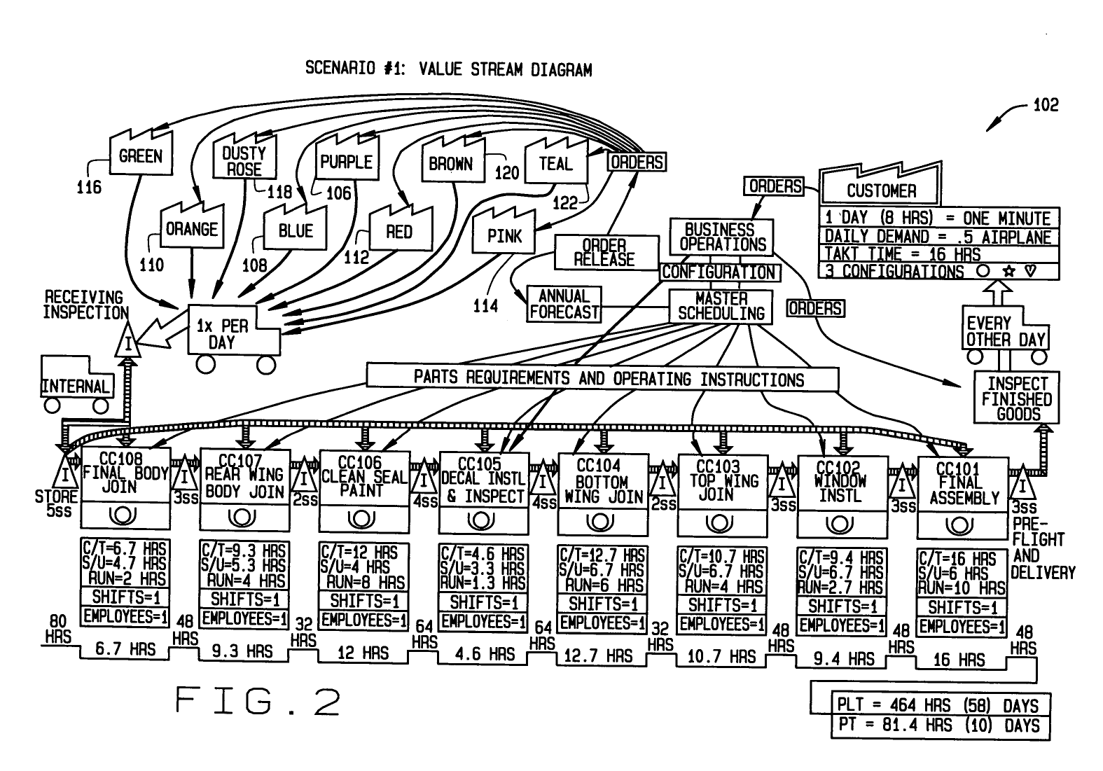

FIG. 1 illustrates a supplier responsibility plan for assembling the toy airplane in accordance with a first assembly scenario 100 representative of a traditional manufacturing environment. FIG. 2 is a value stream diagram 102 illustrating material and information flow during the assembling of the toy airplane in accordance with the first assembly scenario 100. In various implementations, the assembly scenario and value stream diagrams can be colorized, for example, in accordance with the color scheme designated in FIGS. 1 and 2, although such is not required.

As shown in FIGS. 1 and 2, the simulated first assembly scenario 100 includes nine different suppliers 104:
1. Supplier 106 of the upper body, rear wing, rear wheels, and chassis
2. Supplier 108 of the front wheels and window
3. Supplier 110 of the under body
4. Supplier 112 of the motor grill
5. Supplier 114 of the upper wing
6. Supplier 116 of the lower wing
7. Supplier 118 for the nuts and bolts
8. Supplier 120 for the propeller
9. Supplier 122 for the decals

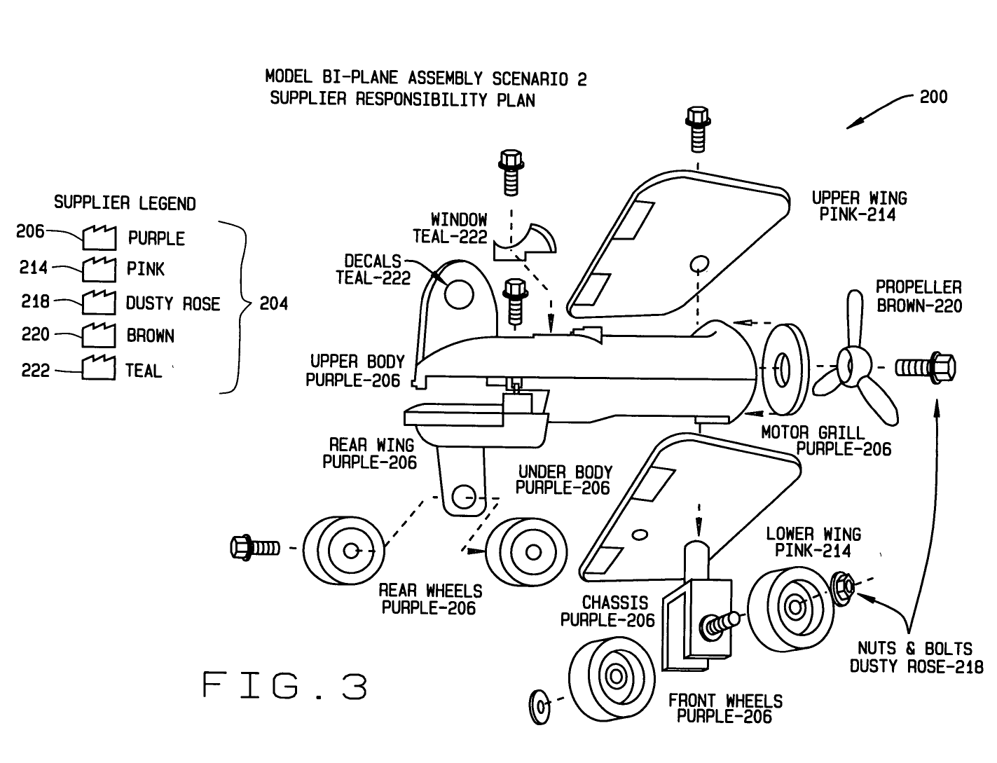

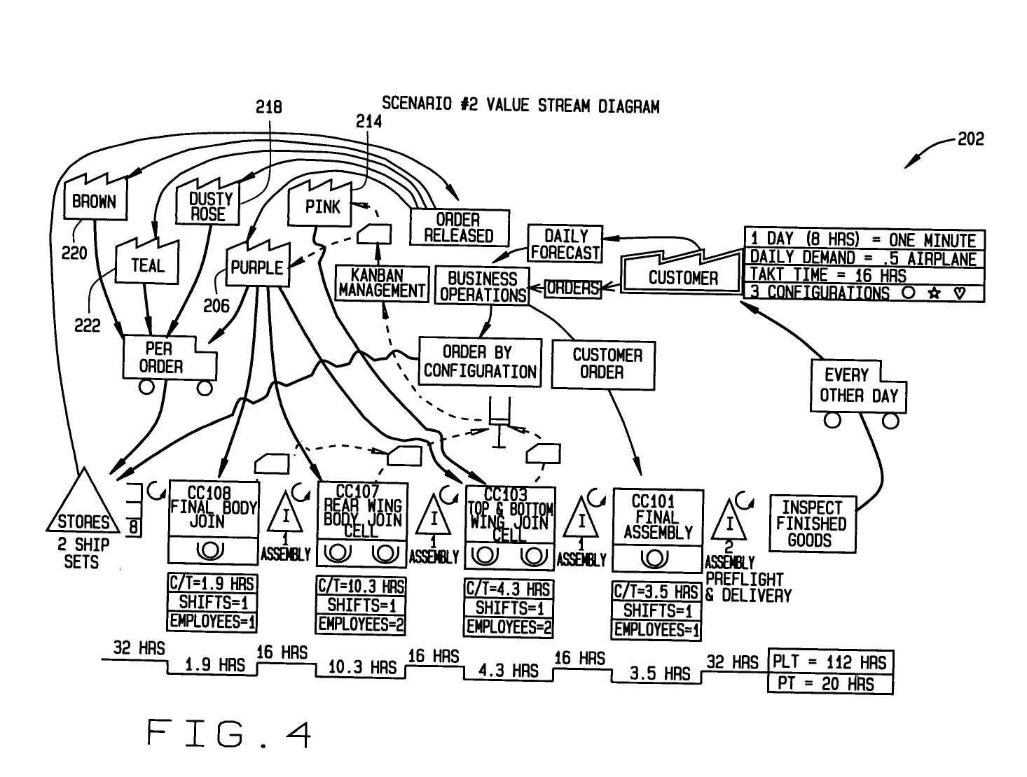

FIG. 3 illustrates a supplier responsibility plan for assembling the toy airplane in accordance with a second assembly scenario 200 representative of a future state exhibiting improved flow. The second assembly scenario 200 includes at least one value stream improvement as compared to the first assembly scenario 100. FIG. 4 is a value stream diagram 202 illustrating material flow and information flow during the assembling of the toy airplane in accordance with the second assembly scenario 200. Supplier consolidation has allowed the number of suppliers for the second assembly scenario 200 to be reduced to five suppliers 204 (recall that the first assembly scenario included nine suppliers 104). The five suppliers 204 for the second assembly scenario 200 include:
1. Supplier 206 of the upper body, under body, rear wing, motor grill, rear wheels, front wheels, and chassis
2. Supplier 214 of the upper and lower wings
3. Supplier 218 of nuts and bolts
4. Supplier 220 of the propeller
5. Supplier 222 of the decals and window

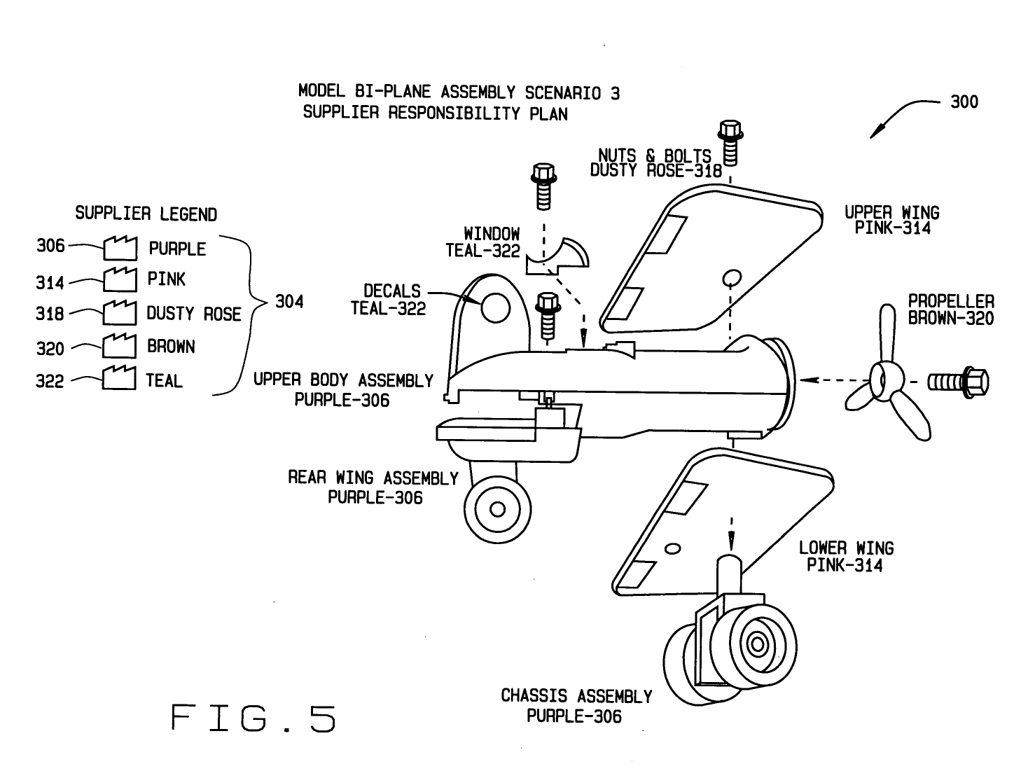

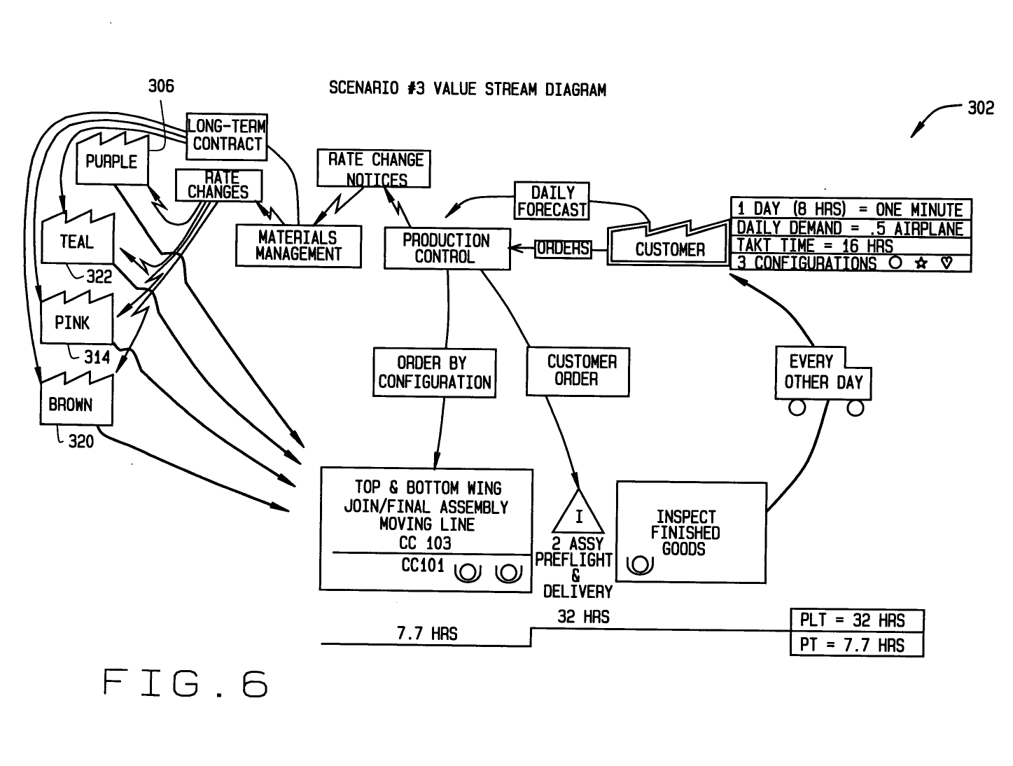

FIG. 5 illustrates a supplier responsibility plan for assembling the toy airplane in accordance with a third assembly scenario 300 representative of a moving production line in which parts are continuously flowing. FIG. 6 is a value stream diagram 302 illustrating material flow and information flow during the assembling of the toy airplane in accordance with the third assembly scenario 300. While the third assembly scenario 300 includes five suppliers 304 as did the second assembly scenario 200, the third assembly scenario 300 includes a value stream improvement in the form of piece-part integration that reduces the number of suppliers and the number of end items delivered to final assembly. The supplier 318 of nuts and bolts is made a sub-tier supplier to the other suppliers to facilitate point-of-use delivery to final assembly. As shown in FIG. 5, the four suppliers 304 to final assembly are as follows:
1. Supplier 306 of the upper body assembly (including the upper body and motor grill), rear wing assembly (including the under body, rear wing, rear wheels) and chassis assembly (including the front wheels, chassis)
2. Supplier 314 of the upper and lower wings
3. Supplier 320 of the propeller
4. Supplier 322 of the decals and window

By having the participants assemble the toy airplane in accordance with each assembly scenario 100, 200, and 300 the participants are able to see the results and effectiveness of the value stream improvements made to the second and third assembly scenarios 200 and 300. Further, the participants will also experience just how busy things are and how much queue and flow time there is associated with the first assembly scenario 100 (which in the illustrated embodiment is representation of a traditional manufacturing environment) for receiving and storing the piece parts until they are ready to become work in process inventory. During the simulation of the first assembly scenario 100, the participants will observe many idle participants waiting on others to complete their tasks, observe inventory stacking up, and note the high number of transactions required.

In a real world traditional manufacturing environment, receipt of piece-parts, storage of inventory and work in progress inventory can involve thousands of transactions in order to build an aircraft or other complex machine. With the above-described simulations, the participants will gain an understanding of the various roadblocks to creating value in a traditional manufacturing environment, with such roadblocks including inflexible manufacturing, inefficient use of space, long reaction time, lots of piece-parts, lots of inventory, lots of suppliers, long flow times, lots of waste, and high cost.

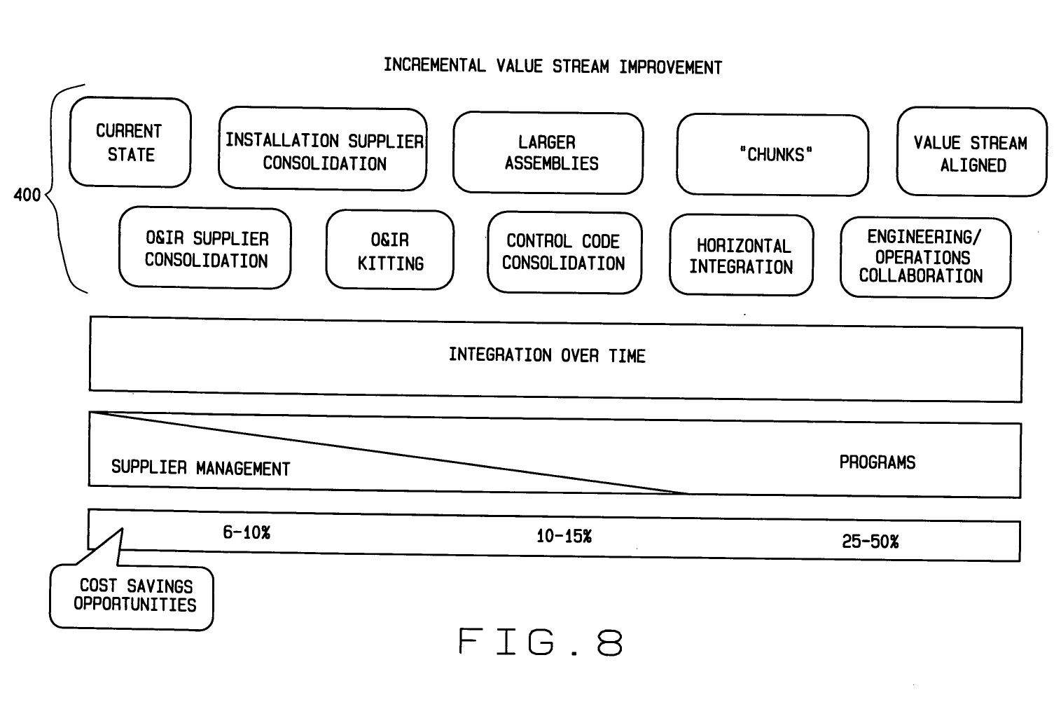

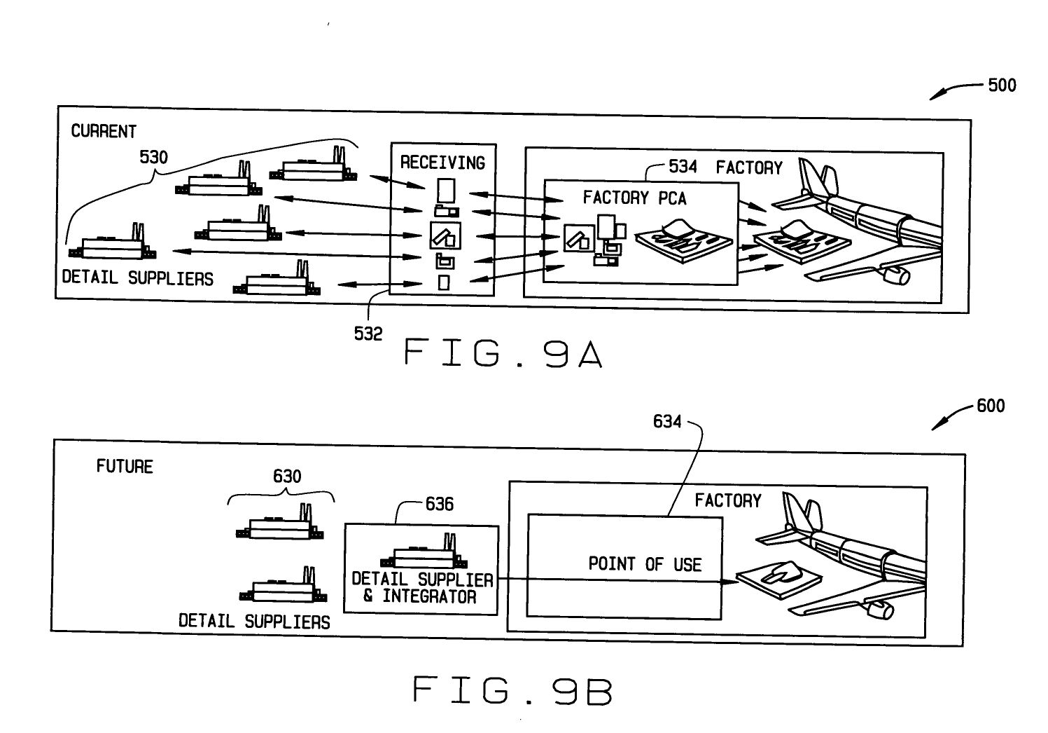

FIG. 8 illustrates various value stream improvements 400 which can be incorporated into a production process to improve the efficiency thereof. FIGS. 9A and 9B respectively illustrate a current state 500 and a future state 600 exhibiting improved flow for an aircraft production process. As shown, the current state 500 (FIG. 9A) includes many external and internal suppliers 530 that ship relatively small parts 532 for final assembly in the factory 534. In contrast, the future state 600 (FIG. 9B) includes far less external and internal suppliers 630. The future state 600 also includes a detail supplier and integrator 636 which ships assembled piece-parts (i.e., assemblies) to the factory 634 for final assembly. These value stream improvements to the future state 600 reduce costs, flow time, number of suppliers that final assembly has to deal with, and number of end items delivered to final assembly. The future state 600 is a more efficient production process than the current state 500 (FIG. 9A).

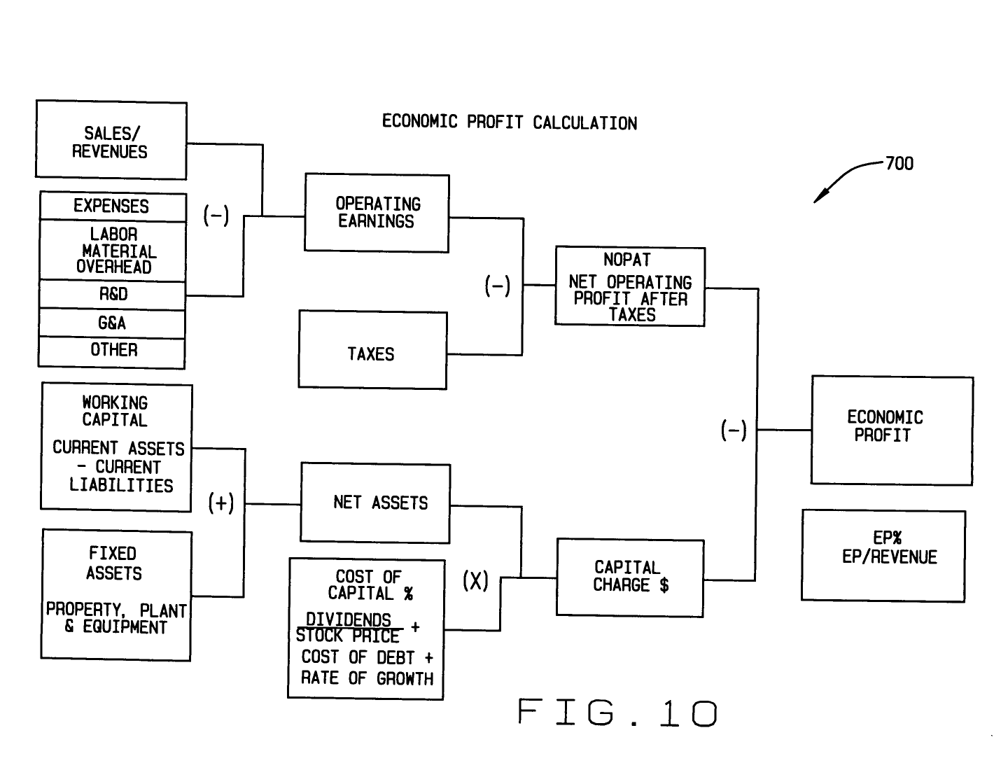

An exemplary way for comparing value stream relationships is to compare economic profit and/or economic profit per as a percentage of revenue. FIG. 10 illustrates a process flow diagram 700 for calculating economic profit. Economic profit (EP) is a metric which indicates how efficiently a company is using its resources and net assets to generate revenue and earnings. EP measures whether money invested in the assets of the company is getting a greater return through operation of the company than it would if invested somewhere else at a specified rate. EP combines both financial operating results and the costs associated with using the enterprise financial resources. Investors and lenders typically evaluate a company using EP wherein a higher EP makes the company a more attractive to investors and lenders.

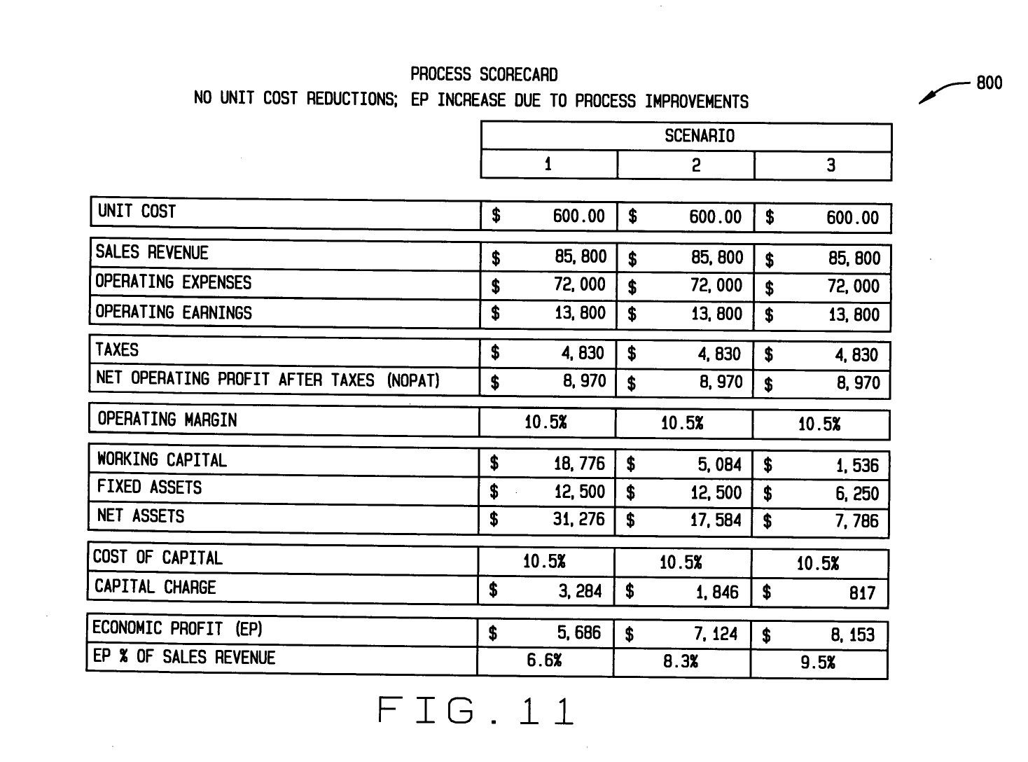

FIG. 11 illustrates a process scorecard 800 created in accordance with the process flow diagram of FIG. 10. The process scorecard 800 provides an effective means of comparing the first, second and third assembly scenarios 100, 200, and 300. The process scorecard 800 provides the economic profit increase due to process improvements but without considering unit cost reductions. This illustrates the value in improving the process even if unit costs do not decline.

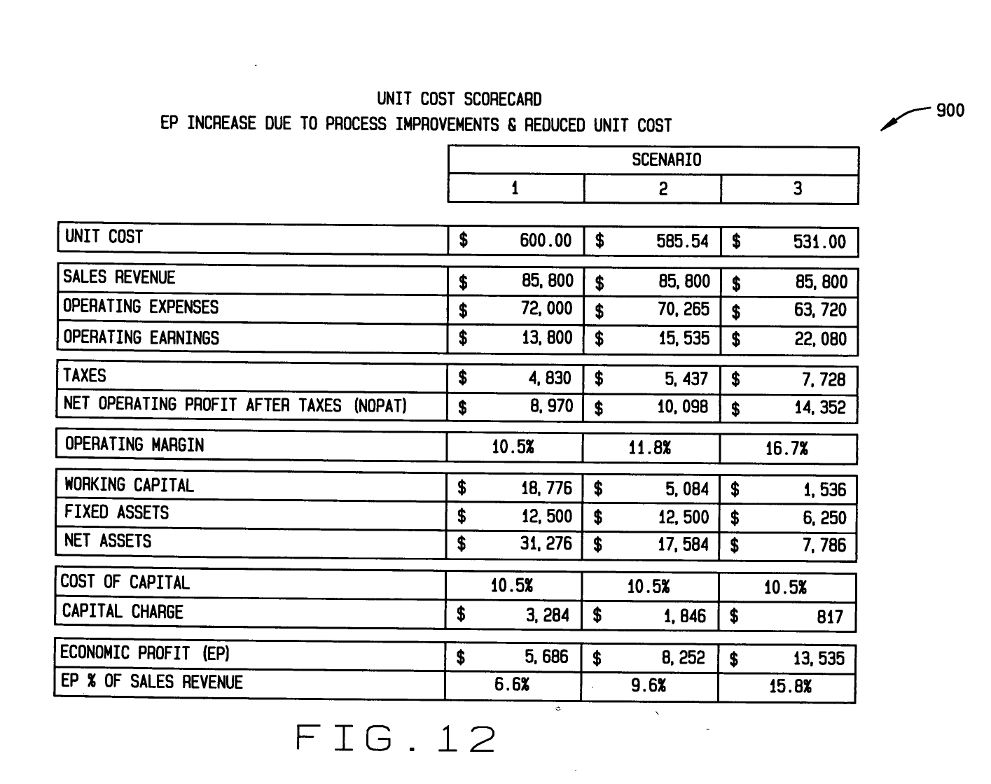

FIG. 12 illustrates a unit cost scorecard 900 created in accordance with process flow diagram of FIG. 10. The unit cost scorecard 900 provides another effective means of comparing the first, second and third assembly scenarios 100, 200, and 300. The unit cost scorecard 900 provides economic profit increase due to process improvements while taking into consideration the reduced unit cost.

As shown in FIGS. 11 and 12, the economic profit improves from the first to the subsequent assembly scenarios for which the flow time and inventory has been reduced.

Various implementations of the invention can include role-playing in which participants are assigned and perform different roles to assemble the physical model. For example, a preferred implementation includes twenty-eight participants each of which are assigned a different role for the simulated assembly process. Exemplary roles for the participants can include customer, business operations, suppliers, stores, stores expedite, tool room, receiving inspection, master scheduling, order release, annual forecast, transportation, inspection, assemblers, kanban management, feeder line, final assembly, pre-flight and delivery, finished goods inspection, recycler, etc. It is understood, however, that the particular roles for the participants will depend upon the particular physical model being assembled and assembly scenario being simulated. For example, as shown in FIG. 1, participants may be assigned supplier roles 104 including supplier 106 (upper body, rear wing, rear wheels and chassis), 108 (front wheels and window), 110 (under body), 112 (motor grill), 114 (upper wing), 116 (lower wing), 118 (nuts and bolts), 120 (propeller), or 122 (decals). Or for example, a participant can be assigned an assembler role such as CC101 (final assembly), CC102 (window installation), CC103 (top wing join), CC104 (bottom wing join), CC105 (decal installation and inspection), CC106 (clean seal paint), CC107 (Rear Wing Body Join), and CC1 08 (Final Body Join).

Preferably, each participant is provided with a badge or other indicator describes his or her role or job function. As the training moves from the first assembly scenario 100 to subsequent assembly scenarios 200 and 300, certain participant roles can be removed and/or combined with another role such that the number of roles required to build the model airplane becomes less. For example, value stream alignment and supplier consolidation and integration can reduce the number of supplier roles. Or for example, the tool room can be combined with the stores role when the tools are kitted and placed in the work areas. Yet another example is the elimination of the role of receiving inspection by making the suppliers source delegated. It should be noted, however, that some participant roles may remain unchanged for the various assembly scenarios, such as the role of customer.

In a preferred implementation, audible cues are used to indicate completed activities and actions (e.g., completion of work or transaction, receipt or delivery of an order, etc.) as the model is being assembled by the participants. For example, an audible sound can be generated by a participant when that participant receives or delivers an order, receives or delivers completed work, completes a transaction, etc.

In this regard, the participants will hear many audible cues as they are assembling the model in accordance with the first assembly scenario 100 (FIGS. 1 and 2). These sounds can thus serve as a very good indication as to how busy things are and how many activities are taking place during the first assembly process 100. In contrast, the participants will readily notice that there are far fewer audible cues during the simulation of the third assembly scenario 300, which is representative of a moving production line in which parts are continuously flowing with less inventory stockpiling and fewer transactions. The participants will also notice that they are moving continually during the third assembly scenario 300 without participants having to wait around. In this exemplary manner, the participants experience what is happening rather than just simply listening to a lecture.

The audible cues can be produced in any number of ways (e.g., manually, automatically, a combination thereof, etc.). Preferably, a unique sound is produced for each type of completed activity or event. For example, a preferred implementation can include the participant who has completed work picking up and shaking a shaker to indicate completion of that work. Or for example, the participant performing a transaction can squeeze a bicycle horn to indicate occurrence of the transaction. Yet another example can include the participant acting as the customer indicating customer demand by ringing a bell at the start of the simulation and when giving an order card to the participant assigned the business operations role. Still yet another example can include the participant functioning as the tool room sounding his or her transaction recorder each time a tool is handed out to or taken in from another participant. Alternatively, other noise-making devices (e.g., sirens, whistles, tambourines, etc.) can be used to indicate completion of activities and actions during the simulated assembly process.

In various implementations, the training session can be rather strictly scripted. By utilizing a scripted format, implementations of the training method can be completed relatively quickly.

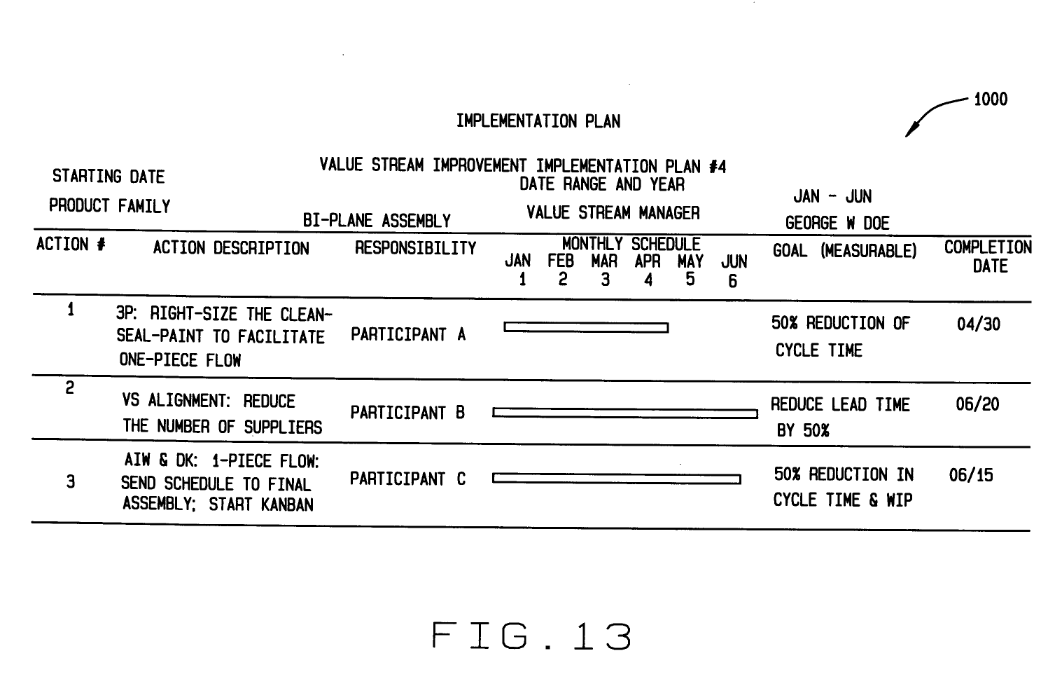

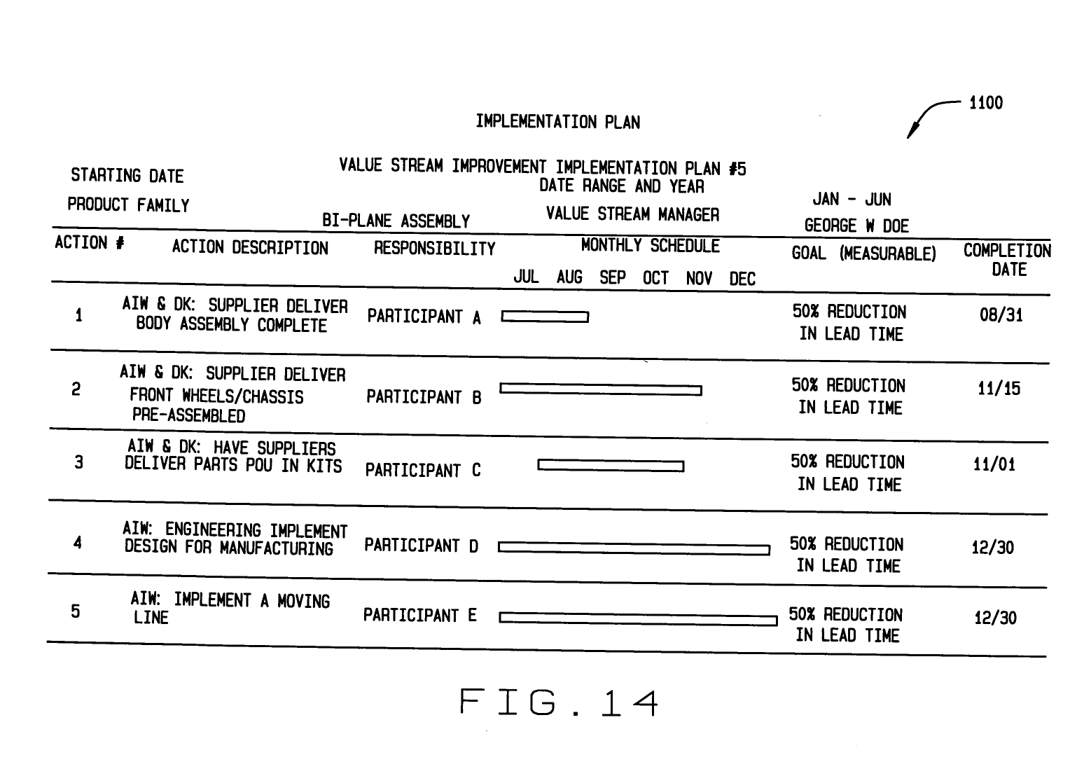

For example, the value stream improvements can be predetermined such that the participants do not have to figure out what improvements can and should be made to the assembly processes. Instead, the value stream improvements can be explained to the participants, for example, by an instructor or coach reading from a script. With the assembly scenarios and value stream improvements being known in advance, the value stream diagrams 100, 200, 300 (FIGS. 2, 4, and 6), scorecards 800 and 900 (FIGS. 11 and 12) and value stream improvement implementation plans 1000 and 1100 (FIGS. 13 and 14) can be prepared in advance for distribution to the students.

Furthermore, the training can be even further scripted in that the participants may be assigned roles and job functions rather than having the participants select and decide for themselves. In addition, details regarding the activities and actions to be performed by the various roles during the assembly process simulation can be provided to the participants, for example, by handing out written instructions and/or by verbal explanations, etc. These instructions will, of course, vary depending upon the particular role, particular model being assembled, and particular assembly scenario being simulated (e.g., traditional manufacturing environment, moving production line, etc).

By way of example, the participant taking on the role as customer can receive the following exemplary instructions. Customer starts simulation by ringing a bell. Every two minutes, Customer gives an order to Business Operations. Each time Customer gives an order card, Customer indicates demand by ringing the bell. Each time the bell rings, Customer should receive an assembled airplane from Finished Goods Inspection. If the assembled airplane has loose parts or misplaced decals, Customer sends the airplane back. When Customer receives an airplane, Customer checks off the “Customer Order/Metrics” card, records satisfaction score and any comments for the manufacturer. Customer places a picture of the airplane on the delivery board and gives the completed airplane to the Recycler.

It should be noted that the preferred implementation of the present invention is in a face-to-face classroom type setting. In addition, the length of the class can vary in duration (e.g., single-day class, week-long class etc.). An exemplary agenda for implementing a training method of the present invention is set forth below:
Introductions and discussion of agenda and course objectives
Explain assembly scenario #1 including each participant's role
Assemble model in accordance with scenario # 1
Count inventory
Calculate economic profit for scenario #1
Discuss value stream improvement and implementation plan
Diagram the future state of scenario #1 (becoming the current state diagram of scenario #2)
Explain assembly scenario #2 including each participant's role
Assemble model in accordance with scenario #2
Count inventory
Calculate economic profit for scenario #2
Discuss value stream improvement and implementation plan
Diagram the future state of scenario #2 (becoming the current state diagram of scenario #3)
Explain assembly scenario #3 including each participant's role
Assemble model in accordance with scenario #3
Count inventory
Calculate economic profit for scenario #3
Compare economic profit calculations for scenarios #1, #2, and #3
Summary, Questions, Class Critiques
Adjourn

It should be noted that various implementations of the training method can include any number of (i.e., one or more) participants and any number of (i.e., one or more) coaches or instructors. By way of example, a preferred implementation includes twenty-eight participants and four coaches/instructors for assisting the participants during the simulations.

Various implementations of the invention can include a wide range of course objectives. Such course objectives can include comparing and contrasting value stream relationships, understanding the value associated with supplier alignment and partnership, participation in customer-supplier interaction, understanding the economic impacts of activities in relationship to the build process, and simulation of a moving production line.

By simulating a moving production line and comparing the same with simulations of less-efficient assembly scenarios, the participants are provided with an effective demonstration of how adopting moving lines can improve production efficiency. Indeed, the simulations allow the students to see not only how value stream improvements can be implemented, but also see the results of those improvements.

Further, the active participatory format tends to reinforce and strengthen the effectiveness of the information being taught during the training. Accordingly, various implementations provide more effective learning tools than solely lecture based approaches.

Various implementations of the invention show value stream as a system rather than vertical organizations and also demonstrate impact to economic profit as improvements are made throughout multiple assembly scenarios. Various implementations can also combine elements of value stream alignment and material and information flow diagramming into a single training seminar or class.

The invention is applicable to a wide range of industries, products and process improvement techniques. Accordingly, the specific references to airplane herein should not be construed as limiting the scope of the present invention, as implementations of the invention could be applicable to virtually any company or entity involved in an assembly and/or manufacturing process in which implementation of a value stream improvement would be desirable.

While various preferred embodiments have been described, those skilled in the art will recognize modifications or variations which might be made without departing from the inventive concept. The examples illustrate the invention and are not intended to limit it. Therefore, the description and claims should be interpreted liberally with only such limitation as is necessary in view of the pertinent prior art.

1. A training method comprising:
simulating a first assembly scenario by having one or more participants assemble a physical model in accordance with the first assembly scenario;
simulating a second assembly scenario by having the participants assemble the physical model in accordance with the second assembly scenario, the second assembly scenario including at least one value stream improvement in comparison to the first assembly scenario; and
comparing the simulations to demonstrate the value stream improvement.

2. The method of claim 1, wherein the comparing comprises comparing a first value stream diagram created in accordance with the first assembly scenario with a second value stream diagram created in accordance with the second assembly scenario.

3. The method of claim 1, wherein the comparing comprises comparing at least one attribute for the simulation of the first assembly scenario with a corresponding attribute for the simulation of the second assembly scenario.

4. The method of claim 1, wherein the comparing comprises comparing an economic profit calculation for the simulation of the first assembly scenario with an economic profit calculation for the simulation of the second assembly scenario.

5. The method of claim 1, wherein simulating a first assembly scenario comprises simulating a traditional manufacturing environment.

6. The method of claim 1, wherein simulating a second assembly scenario comprises simulating improved production flow.

7. The method of claim 1, wherein:
the method further comprises simulating a third assembly scenario by having the participants assemble the physical model in accordance with a third assembly scenario, the third assembly scenario including at least one value stream improvement in comparison to the second assembly scenario;
simulating a first assembly scenario comprises simulating a traditional manufacturing environment; and
simulating a third assembly scenario comprises simulating a moving production line.

8. The method of claim 1, further comprising role-playing with participants assuming roles to assemble the physical model.

9. The method of claim 1, further comprising indicating each completed activity during the simulating.

10. The method of claim 9, wherein the indicating comprises generating an audible cue for each completed activity.

11. The method of claim 10, wherein generating an audible cue comprises a corresponding participant using a noisemaker to generate the audible cue upon completion of the activity by the corresponding participant.

12. The method of claim 10, wherein generating an audible cue comprises generating a unique audible cue for each type of completed activity.

13. The method of claim 1, further comprising following a script during the simulating and comparing.

14. The method of claim 1, wherein the physical model comprises a model aircraft.

15. A training method comprising:
simulating a first assembly scenario by participants role-playing to assemble a physical model in accordance with the first assembly scenario and indicating each completed activity; and
simulating a second assembly scenario by participants role-playing to assemble the physical model in accordance with the second assembly scenario and indicating each completed activity, the second assembly scenario including at least one value stream improvement in comparison to the first assembly scenario.

16. The method of claim 15, further comprising comparing the simulations to determine effectiveness of the value stream improvement.

17. The method of claim 15, further comprising an economic profit calculation for the simulation of the first assembly scenario with an economic profit calculation for the simulation of the second assembly scenario.

18. The method of claim 15, wherein:
simulating a first assembly scenario comprises simulating a traditional manufacturing environment; and
simulating a second assembly scenario comprises simulating a production line with improved flow.

19. The method of claim 15, wherein the indicating comprises generating an audible cue for each completed activity.

20. The method of claim 19, wherein generating an audible cue comprises a corresponding participant using a noisemaker to generate the audible cue upon completion of the activity by the corresponding participant.

21. The method of claim 19, wherein generating an audible cue comprises generating a unique audible cue for each type of completed activity.

22. An interactive training method comprising simulating and role-playing by participants, wherein the participants assume different roles to simulate at least one assembly scenario to demonstrate at least one value stream improvement opportunity which can be made to the assembly scenario.

23. The method of claim 22, wherein the simulating includes the participants assembling a physical model in accordance with the assembly scenario.

24. The method of claim 22, further comprising indicating each completed activity during the simulation.

25. The method of claim 24, wherein the indicating comprises generating an audible cue for each completed activity.

26. The method of claim 25, wherein generating an audible cue comprises a corresponding participant completing using a noisemaker to generate the audible cue upon completion of the activity by the corresponding participant.

27. The method of claim 24, wherein generating an audible cue comprises generating a unique audible cue for each type of completed activity.
